(19) United States
(12) Patent Application Publication
(10) Pub. No.: US 2023/0302909 A1
(43) Pub. Date: Sep. 28, 2023

(54) BATTERY MANAGEMENT APPARATUS

(71) Applicant: Isuzu Motors Limited, Yokohama-shi (JP)

(72) Inventors: Takuya KIKUCHI, Fujisawa-shi (JP); Kenta KAMEDA, Fujisawa-shi (JP)

(73) Assignee: Isuzu Motors Limited, Yokohama-shi (JP)

(21) Appl. No.: 18/124,596

(22) Filed: Mar. 22, 2023

(30) Foreign Application Priority Data
Mar. 23, 2022 (JP) 2022-047102

(51) Int. Cl. B60L 3/00; B60L 58/18

(52) U.S. Cl. CPC B60L 3/0046; B60L 58/18; B60L 2250/00

(57) ABSTRACT

A battery management apparatus is a battery management apparatus configured to manage a plurality of battery packs that are mounted in a vehicle and connected in parallel, the battery management apparatus including: a storage section configured to store a first computer program used in the battery management apparatus and a second computer program used in each of the plurality of battery packs; a judgment section configured to judge whether or not there is a mismatch between version information of the second computer program stored in each of the plurality of battery packs and version information of each of the first computer program and the second computer program stored in the storage section; and a notification section configured to notify a host computer of the battery management apparatus of the mismatch of the version information when there is the mismatch.

### CROSS REFERENCE TO RELATED APPLICATIONS

This application claims the benefit of priority of Japanese Patent Application No. 2022-047102 filed on Mar. 23, 2022, the contents of which are incorporated herein by reference in their entirety.

### TECHNICAL FIELD

The present disclosure relates to a battery management apparatus.

### BACKGROUND ART

Conventionally, a system for an automobile is known in which a plurality of battery packs are connected in parallel, and Battery Management Systems (BMSs) mounted in the respective battery packs perform Controller Area Network (CAN) communication with a host controller (see, for example, Patent Literature (hereinafter, referred to as “PTL”) 1).

### CITATION LIST

### Patent Literature

PTL 1
Japanese Unexamined Patent Application Publication (Translation of PCT Application) No. 2019-532605

### SUMMARY OF INVENTION

### Technical Problem

In the above-described system, computer programs for implementing functions of the host controller and the BMSs are executed. With regard to this computer programs, it is desired to ensure safety.

An object of one aspect of the present disclosure is to provide a battery management apparatus capable of ensuring safety.

### Solution to Problem

A battery management apparatus according to one aspect of the present disclosure is a battery management apparatus configured to manage a plurality of battery packs that are mounted in a vehicle and connected in parallel, the battery management apparatus including: a storage section configured to store a first computer program used in the battery management apparatus and a second computer program used in each of the plurality of battery packs; a judgment section configured to judge whether or not there is a mismatch between version information of the second computer program stored in each of the plurality of battery packs and version information of each of the first computer program and the second computer program stored in the storage section; and a notification section configured to notify a host computer of the battery management apparatus of the mismatch of the version information when there is the mismatch.

### Advantageous Effects of Invention

According to the present disclosure, it is possible to ensure safety.

### BRIEF DESCRIPTION OF DRAWINGS

FIG. 1 is a schematic diagram illustrating a configuration of a battery pack system according to an embodiment;

FIG. 2 is a block diagram illustrating a configuration of an MBMS according to the embodiment; and

FIG. 3 is a flowchart illustrating an operation of the MBMS according to the embodiment.

### DESCRIPTION OF EMBODIMENTS

Hereinafter, an embodiment of the present disclosure will be described with reference to the drawings.

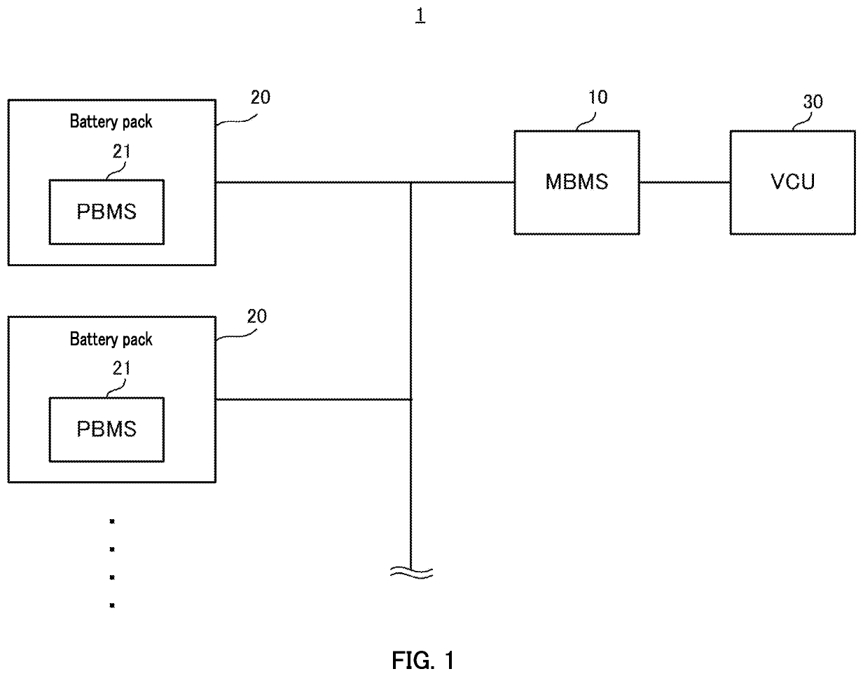

To begin with, the configuration of battery pack system 1 according to the present embodiment will be described with reference to FIG. 1. FIG. 1 is a schematic diagram illustrating an exemplary configuration of battery pack system 1.

Battery pack system 1 illustrated in FIG. 1 is mounted in a vehicle (for example, an electric vehicle).

Battery pack system 1 includes one Master Battery Management System (MBMS) 10, a plurality of battery packs 20, and one Vehicle Control Unit (VCU) 30.

The plurality of battery packs 20 are connected in parallel. Each of battery packs 20 includes Pack Battery Management System (PBMS) 21. Although not illustrated, each of battery packs 20 includes a rechargeable secondary battery, a high-voltage relay (for example, a positive-side relay and a negative-side relay), a resistor, a voltmeter, an ammeter, and the like.

VCU 30 is a computer that performs a general control of an automobile. VCU 30 corresponds to a host computer (controller) of MBMS 10.

MBMS 10 is a computer that mainly manages each battery pack 20. MBMS 10 corresponds to one example of “battery management apparatus.”

PBMS 21 is a computer that mainly monitors the state of battery pack 20 and controls driving of the high-voltage relay. Examples of the state of battery pack 20 include a current, a voltage, a temperature, a degree of degradation, and a charge amount (State Of Charge (SOC)) in battery pack 20.

MBMS 10 communicates with each of VCU 30 and PBMS 21 by a Controller Area Network (CAN).

Although not illustrated, a computer program is stored in each of MBMS 10 and PBMS 21.

MBMS 10 holds a computer program used in MBMS 10 (hereinafter, referred to as a MBMS program; one example of a first computer program) and a computer program used in PBMS 21 (hereinafter, referred to as a PBMS program; one example of a second computer program). PBMS 21 holds the PBMS program.

The MBMS program and the PBMS program are written in MBMS 10 using a predetermined apparatus. Then, the PBMS program is sent distributedly to PBMSs 21 from MBMS 10.

Each of the MBMS program and the PBMS program includes version information.

The configuration of battery pack system 1 has been described above.

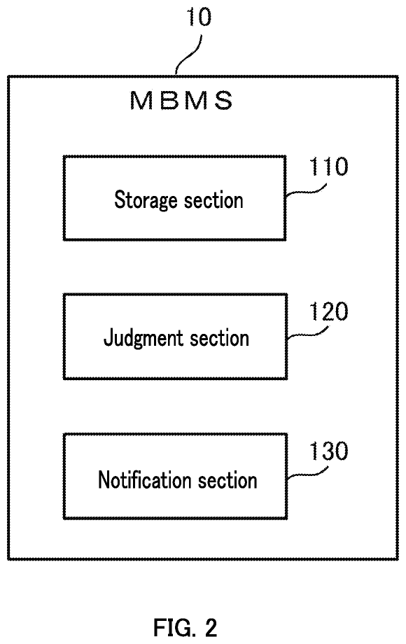

Next, the configuration of MBMS 10 according to the present embodiment will be described with reference to FIG. 2. FIG. 2 is a block diagram illustrating an exemplary configuration of MBMS 10.

Although not illustrated, MBMS 10 includes, as hardware, for example, a Central Processing Unit (CPU), a Read Only Memory (ROM) in which a computer program is stored, and a Random Access Memory (RAM), which is a working memory. The functions described below are implemented by the CPU executing, in the RAM, the computer program read from the ROM.

As illustrated in FIG. 2, MBMS 10 includes storage section 110, judgment section 120, and notification section 130.

Storage section 110 stores the MBMS program and the PBMS program.

When the vehicle (battery pack system 1) is started, judgment section 120 judges whether or not there is a mismatch between the version information of the PBMS program stored in each of battery packs 20 (each of PBMSs 21) and the version information of each of the MBMS program and the PBMS program stored in storage section 110.

Examples of patterns of the mismatch include, but not limited thereto, a case where the version information stored in storage section 110 differs from the version information stored in each of PBMSs 21, a case where the version information stored in one of the plurality of PBMSs 21 differs from the version information stored in other PBMSs 21 and the version information stored in storage section 110, and other cases.

When there is a mismatch, notification section 130 notifies VCU 30 of the mismatch of the version information. Accordingly, VCU 30 prohibits an operation (movement) of the vehicle.

In addition, notification section 130 may control an onboard broadcast apparatus (not illustrated) such that the onboard broadcast apparatus broadcasts the fact that there is a mismatch of the version information (which may also be referred to as the fact that the operation of the vehicle is prohibited). Accordingly, an occupant of the vehicle can easily recognize the mismatch of the version information (prohibition of the operation of the vehicle). Examples of the onboard broadcast apparatus include, but not limited thereto, instruments (meter panels) disposed in a vehicle cabin, and examples of modes of broadcast include, but not limited thereto, display of a mark (image) representing the mismatch of version information or prohibition of the operation of the vehicle.

The configuration of MBMS 10 has been described above.

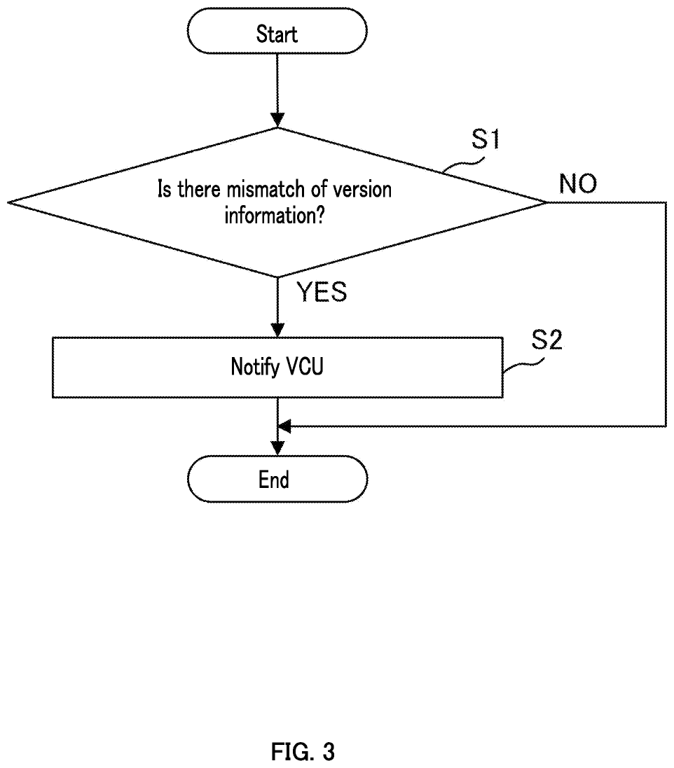

Next, the operation of MBMS 10 will be described with reference to FIG. 3. FIG. 3 is a flowchart illustrating the operation of MBMS 10.

The process illustrated in FIG. 3 is started, for example, when the vehicle (battery pack system 1) is started.

To begin with, judgment section 120 judges whether or not there is a mismatch between the version information of the PBMS program stored in each of battery packs 20 (each of PBMSs 21) and the version information of each of the MBMS program and the PBMS program stored in storage section 110 (step S1).

When there is no mismatch of the version information (step S1: NO), the process ends. In this case, the process may be started again at a predetermined timing.

On the other hand, when there is a mismatch of the version information (step S1: YES), notification section 120 notifies VCU 30 of the mismatch of the version information (step S2). Accordingly, VCU 30 prohibits the operation of the vehicle.

As described above, MBMS 10 according to the present embodiment is a battery management apparatus that is mounted in a vehicle and manages a plurality of battery packs connected in parallel, the battery management apparatus including: storage section 110 that stores a first computer program used in the battery management apparatus and a second computer program used in each of the plurality of battery packs; judgment section 120 that judges whether or not there is a mismatch between version information of the second computer program stored in each of the plurality of battery packs and version information of each of the first computer program and the second computer program stored in storage section 110; and notification section 130 that, when there is a mismatch, notifies a host computer of the battery management apparatus of the mismatch of version information.

It is possible to suppress the occurrence of malfunction caused by a difference in version of the computer program. That is, MBMS 10 of the present embodiment can ensure safety.

Note that the present disclosure is not limited to the description of the above-described embodiment, and various modifications can be made without departing from the gist thereof.

### INDUSTRIAL APPLICABILITY

The battery management apparatus of the present disclosure is useful when a computer program is shared between a slave and a master.

What is claimed is:

1. A battery management apparatus configured to manage a plurality of battery packs that are mounted in a vehicle and connected in parallel, the battery management apparatus comprising:
a storage section configured to store a first computer program used in the battery management apparatus and a second computer program used in each of the plurality of battery packs;
a judgment section configured to judge whether or not there is a mismatch between version information of the second computer program stored in each of the plurality of battery packs and version information of each of the first computer program and the second computer program stored in the storage section; and
a notification section configured to notify a host computer of the battery management apparatus of the mismatch of the version information when there is the mismatch.

2. The battery management apparatus according to claim 1, wherein
when the vehicle is started, the judgment section judges whether or not there is the mismatch.

3. The battery management apparatus according to claim 1, wherein
the notification section controls an onboard broadcast apparatus such that broadcast indicating that there is the mismatch of the version information is performed.
